(19) United States
(12) Patent Application Publication
(10) Pub. No.: US 2016/0175885 A1
(43) Pub. Date: Jun. 23, 2016

(54) ONE-GLASS-SOLUTION (OGS) TOUCH PANEL, MANUFACTURING DEVICE AND MANUFACTURING METHOD THEREOF

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Mingtao HOU, Beijing (CN); Wei JI, Beijing (CN)

(21) Appl. No.: 14/751,460

(22) Filed: Jun. 26, 2015

(30) Foreign Application Priority Data
Dec. 23, 2014 (CN) 201410814459.5

(51) Int. Cl. B05D 3/14; B05D 3/06

(52) U.S. Cl. CPC B05D 3/142; B05D 3/067

(57) ABSTRACT

A device and a method for manufacturing a one-glass-solution (OGS) touch panel and an OGS touch panel are disclosed. The device for manufacturing the OGS touch panel is configured to achieve secondary ink printing in the manufacturing process of the OGS touch panel. The manufacturing device comprises: a processing section configured to perform plasma cleaning on a layer to be coated on a cover glass plate; and a manufacturing section configured to form a supplementary ink layer on the layer to be coated that has been subjected to plasma cleaning, in which the supplementary ink layer is made from UV curing ink.

### TECHNICAL FIELD

Embodiments of the present disclosure relate to a one-glass-solution (OGS) touch panel and a manufacturing device and a manufacturing method thereof.

### BACKGROUND

OGS touch panel technology is such a technology in which an indium tin oxide (ITO) conductive film and a sensor are directly formed on a cover glass plate (cover plate), and the glass plate can have dual functions of the cover glass and the touch sensor at the same time. Compared with the conventional touch panel, the unique structure of the OGS touch panel allows an OGS touch panel to save one layer of glass and reduce the cost of one bonding process, reduces the weight and the thickness of the touch panel, and increases the transmittance of the touch panel.

In the manufacturing process of the OGS touch panel, in addition to perform a primary ink printing process on the cover glass to form primary black matrixes (BMs), a secondary ink printing process is performed to form a black frame of the OGS touch panel and repair the primary BMs.

The ink commonly used in the secondary ink printing process of the conventional OGS touch panel is a kind of thermosetting ink. The conventional thermosetting ink has the defects that: more than 60% of its organic solvent is volatilized after curing, so that there is produced large pollution and damage to human health, and the problem of inconsistent thickness before and after volatilization due to the volatilization of the solvent can be caused. Because the solvent ink is a kind of bi-component ink, along with the printing process, screens can be blocked due to slow reaction and volatilization, it is necessary to frequently wipe and clean the screens, and hence the loss of utilization of equipment is serious and the production line combination (in-line) mode is difficult to implement; and as the ink has a long drying cycle (30 minutes), it is difficult to organize a rapid printing production line, so that the printing efficiency is low, the investment in manufacturing devices is high, the occupied space is large, the printing area is small, and each kilogram of solvent ink may be used to print the area of 50 m² under the requirement of 10-15 μm film thickness, and the like.

For the secondary ink printing process of the conventional OGS touch panel, after feeding the raw material, aligning and performing the secondary ink printing, the cover glass is conveyed into a high temperature furnace and backed for 30 minutes at the temperature of 150-180 centigrade degrees so as to achieve ink curing, and the next process is executed after curing. In the process, the ink curing mechanism/machine is complex. In order to satisfy the production requirements, an oven having 92 layers (46 layers*2) and having a height of up to 3.2 m is needed, and it is not convenient for daily equipment maintenance of the oven. Moreover, the temperature of the oven is 150-180 centigrade degrees, so that the temperature of products obtained after curing is overly high, and hence a cooler is added to cool the products. Therefore, the equipment cost is high. In addition, as the duration of the entire curing process is more than 40 minutes, timely sampling inspection cannot be achieved, which is not conducive to quality control.

### SUMMARY

Embodiments of the present disclosure provide an OGS touch panel and a manufacturing device and a manufacturing method thereof, which can simplify the manufacturing process of the touch panel, improve the production efficiency of the OGS touch panel and reduce the manufacturing costs of the OGS touch panel.

In one aspect, an embodiment of the present disclosure provides a device for manufacturing an OGS touch panel, which is configured to achieve secondary ink printing in the manufacturing process of the OGS touch panel. The manufacturing device comprises: a processing section configured to perform plasma cleaning on a layer to be coated on a cover glass plate; and a manufacturing section configured to form a supplementary ink layer on the layer to be coated that has been subjected to plasma cleaning, in which the supplementary ink layer is made from UV curing ink.

In another aspect, an embodiment of the present disclosure further provides a method for manufacturing an OGS touch panel, for achieving secondary ink printing in the manufacturing process of the OGS touch panel. The method comprises: performing plasma cleaning on a layer to be coated on a cover glass plate; and forming a supplementary ink layer on the layer to be coated that has been subjected to plasma cleaning, in which the supplementary ink layer is made from UV curing ink.

In still another aspect, an embodiment of the present disclosure further provides an OGS touch panel, which comprises: a cover glass plate; a layer to be coated disposed on the cover glass plate and subjected to plasma cleaning; and a supplementary ink layer formed on the layer to be coated and made from UV curing ink.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative of the disclosure.

FIG. 1 is a structural block diagram of a device for manufacturing an OGS touch panel, provided by an embodiment of the present disclosure;

FIG. 2 is a structural block diagram of a manufacturing section in the embodiment of the present disclosure;

FIG. 3A and FIG. 3B are a schematic structural sectional views of an OGS touch panel provided by embodiments of the present disclosure;

FIG. 4 is another schematic structural sectional view of the OGS touch panel provided by the embodiment of the present disclosure;

FIG. 5 is still another schematic structural sectional view of the OGS touch panel provided by the embodiment of the present disclosure; and

FIG. 6 is a structural block diagram of a device for manufacturing an OGS touch panel, provided by the embodiment of the present disclosure.

### DETAILED DESCRIPTION

For more clear understanding of the objectives, technical proposals and advantages of the embodiments of the present disclosure, clear and complete description will be given below to the technical proposals of the embodiments of the present disclosure with reference to the accompanying drawings of the embodiments of the present disclosure. Obviously, the preferred embodiments are only partial embodiments of the present disclosure but not all the embodiments. All the other embodiments obtained by those skilled in the art without creative efforts on the basis of the embodiments of the present disclosure illustrated shall fall within the scope of protection of the present disclosure.

Unless otherwise defined, the technical terms or scientific terms used herein shall have normal meaning understood by those skilled in the art. The words “first”, “second” and other similar words used in the description and the claims of the patent application of the present disclosure do not represent the sequence, the quantity or the importance and are only intended to distinguish different components. Similarly, the words “a”, “an” and other similar words do not represent the quantity and only indicate at least one. The words “connection”, “connected” and other similar words are not limited to physical or mechanical connection but may include electrical connection, whether direct or indirect. The words “on”, “beneath”, “left”, “right” and the like are only intended to indicate the relative positional relationship which is changed accordingly when the absolute position of the object is changed.

An embodiment of the present disclosure provides a device for manufacturing an OGS touch panel, and the device is configured to achieve secondary ink printing in the manufacturing process of the OGS touch panel. As illustrated in FIG. 1, illustratively, the device may comprise: a processing section 1 configured to perform plasma cleaning on a layer to be coated on cover glass plate 11; and a manufacturing section 2 configured to form a supplementary ink layer 12 on the layer to be coated subjected to plasma cleaning, in which the supplementary ink layer 12 is made from UV curing ink.

In the device for manufacturing an OGS touch panel, provided by an embodiment of the present disclosure, in the secondary ink printing process of the OGS touch panel, UV curing ink is used to replace a conventional thermosetting ink to form the supplementary ink layer 12. As the UV ink has the characteristics of rapid curing time period, low curing condition and curing cost, and the like, the manufacturing process of the OGS touch panel can be simplified; the production efficiency of the OGS touch panel can be improved; and the manufacturing cost of the OGS touch panel can be reduced.

Moreover, in the device for manufacturing the OGS touch panel, provided by the embodiment of the present disclosure, good adhesion between the UV ink (namely the supplementary ink layer 12) and a layer to be coated, which makes contact with the UV ink, in an OGS touch panel structure can also be achieved by performing plasma cleaning on the layer to be coated on the cover glass plate 11, so that the detachment of UV ink can be avoided.

The UV ink adopted in the embodiment of the present disclosure may illustratively be such a kind of ink: monomers in the ink are polymerized into polymers by irradiation of UV-light with different wavelengths and energy, so that the process of film forming and ink drying can be achieved. The selection may be based on the factors, such as adsorption, optical density (OD), ink thickness, ink hardness, high temperature and high humidity, artificial sweat resistance, cold and thermal shock, boiling water resistance, alcohol resistance, abrasion resistance, UV ink irradiation, salt fog test, Logo ink compatibility, and the impact of acid-resistant films on UV ink printing. The exemplary test items and test processes may be as shown in Table 1:

TABLE 1

| | | Standard Test |
|---|---|---|
| Test Item | Test Method & Spec. | Number |
| Adsorption | 3M610 scotch tape test, vertical peeling for three times, with the | 2 |
| | adhesion of more than 4B | |
| Ink Thickness | printing with a 420-mesh screen for one time, dry film thickness | 2 |
| | of 10 to 14 μm actually measured by a film thickness gauge | |
| Ink Hardness | 750 ± 10 g pressure, at an angle of 45 centigrade degrees with | 2 |
| | respect to the test surface, with the speed of 0.5 mm-1 mm/S, | |
| | with the distance of 7 mm (China Pencil 4H), with no scratch | |
| Optical Density | With the optical density (OD) value of ≧3 tested by an OD tester | 2 |
| | after the drying of 420-mesh screen printed ink | |
| High | 65° C., 90% RH, test for 240 hours, characteristic test, more than | 6 |
| Temperature | 4B after scotch tape test | |
| and High | | |
| Humidity | | |
| Artificial Sweat | Test Procedure: | 4 |
| Resistance | 1. Respectively uniformly coating liquid with the PH value of | |
| | 4.7 and liquid with the PH value of 8.7 on surfaces of different | |
| | ink products by cotton swabs; | |
| | 2. placing for 24 h at 25-35° C./humidity 30% to 60% to let the | |
| | solvent dry; | |
| | 3. Checking after 72 h high temperature and high humidity test | |
| | and determining no change in appearance, no detachment. | |
| Cold & | Alternating high and low temperature test box for 200 cycles, | 6 |
| Thermal Shock | each comprising 60° C. for 24 min and −20° C. for 24 min; | |
| | characteristic test, more than 4B after scotch tape test | |
| Boiling Water | Boiled in 100° C. boiling water for 60 min; characteristic test, | 2 |
| Resistance | more than 4B after scotch tape test | |
| Alcohol | Rubbing with white clean cloth dipped in 98% alcohol at a force | 2 |
| Resistance | of 500 g, showing fadeless after 100 times of round trip | |
| Abrasion | Rubbing with white clean cloth at a force of 500 g, showing | 2 |
| Resistance | fadeless after 100 times of round trip | |
| UV Irradiation I | 4 h UV light source test, under the energy of 0.77 W/cm², under | 4 |
| | the environment of 40-50° C., no change in appearance, no | |
| | detachment | |
| UV Irradiation | Printing Ink on white glass with the printed surface facing down, | 2 |
| II | receiving 6000 mw/cm² accumulated light intensity within 25 | |
| | seconds (metal halide lamps), repeating for three times, and no | |
| | change in appearance and no detachment | |
| Salt Fog Test | At 35° C., spraying for 2 h at 40° C., 93% Relative Humidity (RH) | 4 |
| | environment for 96 hours, characteristic test, more than 4B after | |
| | scotch tape test (with saline water (NaCl 5% and fresh water | |
| | 95%)) | |
| Logo Ink | UV ink printed on solvent Logo ink to confirm the adhesion | 2 |
| Compatibility | reliability (mirror silver, etc) | |
| Impact of | Bonding an acid-resistant film to a cleaned product → heating at | 2 |
| Acid-resistant | 120° C./30 min → peeling cleaning → printing → adhesion | |
| Films on UV | confirmation (recording the change of the surface contact angle | |
| Ink Printing | of the product) | |

In the device for manufacturing the OGS touch panel, provided by an embodiment of the present disclosure, the supplementary ink layer 12 formed in the secondary ink printing process and made from UV ink can be adopted as a black frame of the OGS touch panel and may be further configured to repair the primary BMs 13 formed in the primary ink printing process.

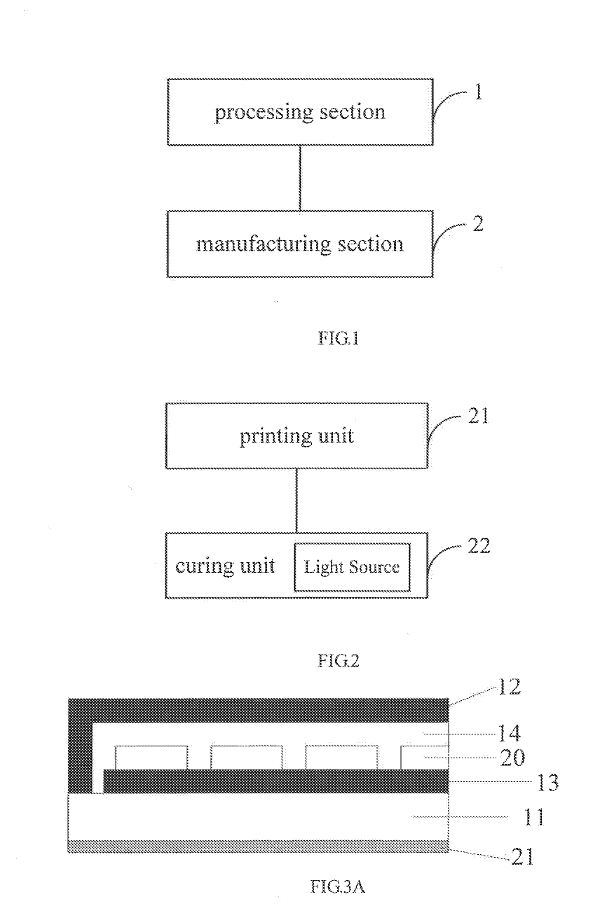

In one example, as illustrated in FIG. 2, the manufacturing section 2 in the embodiment of the present disclosure may include: a printing unit 21 configured to form supplementary ink on the layer to be coated subjected to plasma cleaning by printing process; and a curing unit 22 configured to cure the supplementary ink by photo-curing to form the supplementary ink layer 12.

Illustratively, the curing unit 22 in an embodiment of the present disclosure may comprise a UV ink curing light source, e.g., a mercury lamp, a halogen lamp, or the like. As a plurality of layers in the OGS touch panel have inconsistent optical densities to each other, in order to ensure the UV ink reaction rate, in the embodiment of the present disclosure, halogen lamps with higher transmittance may be taken as the curing light sources of the UV ink. The halogen lamps, for instance, may be metal halide lamps.

As the UV ink has a short curing timing and can be almost instantly cured, the embodiment of the present disclosure obviously accelerates the conduction of the secondary ink printing process of the OGS touch panel and hence improves the production efficiency of the OGS touch panel. Moreover, as the UV ink needs sample curing conditions and low curing cost, only a curing light source is required to irradiate the UV ink. Therefore, the costs of secondary ink printing equipment of the OGS touch panel can be obviously reduced; the manufacturing process of the OGS touch panel can be simplified; and the manufacturing cost of the OGS touch panel can be reduced.

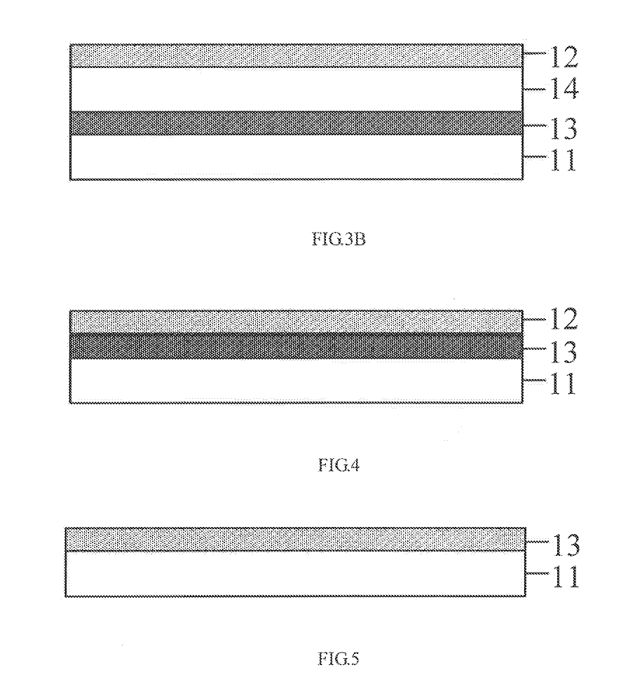

As shown in FIG. 3A, the OGS touch panel provided by an embodiment of the present disclosure may comprise a cover glass plate 11, primary BMs 13, an insulating overcoat (OC) 14, a metal layer 20, an anti-fingerprint surface 21 (AFS) and other layer(s), if needed; the primary BMs 13 formed on the cover glass plate 11 may be made of a light-tight (light-proofing) photoresist layer and disposed on the periphery of a visual area of the OGS touch panel; the metal layer is formed on the primary BMs 13; and the insulating OC 14 has high transmittance and is disposed on the metal layer and configured to prevent the oxidation and heat loss of the metal layer.

The supplementary ink layer 12 (UV ink) in the embodiment of the present disclosure may be disposed on the insulating OC 14 or the primary BMs 13, namely the layer to be coated in the embodiment of the present disclosure may be the insulating OC 14, the primary BMs 13, or the like.

As illustrated in FIG. 3B, in another embodiment, when the supplementary ink layer 12 is disposed on the insulating OC 14, because the material of the insulating OC 14 has low adhesion to UV ink, if the supplementary ink layer 12 is directly printed on the insulating OC 14, the supplementary ink layer 12 may be peeled off.

Therefore, in the embodiment of the present disclosure, the processing section 1 may be adopted at first to perform plasma cleaning on the surface of the insulating OC 14, so that the surface contact angle of the insulating OC 14 can be reduced, for instance, reduced from 80 degrees to about 30 degrees, and hence the adhesion (B) between the supplementary ink layer 12 and the insulating OC 14 can be strengthened (which may reach more than 5B). Therefore, the problem of insufficient adhesion of UV ink on the insulating OC 14 can be resolved.

In another example, the processing section 1 may be also configured to form an adhesion layer (not shown in the figure) on the insulating OC 14. The adhesion layer can ensure that the adhesion between the UV ink and the insulating OC 14 satisfies the predetermined requirements. Therefore, the problem of insufficient adhesion of UV ink on the insulating OC 14 can also be resolved, and the phenomena such as the peeling-off of the UV ink after printing and insufficient adhesion can be avoided.

After the surface of the insulating OC 14 is subjected to plasma cleaning, the printing unit 21 may be adopted to form supplementary ink on the insulating OC 14 subjected to plasma cleaning by printing process. Subsequently, the curing unit 22 may be adopted to perform photo-curing process on the supplementary ink to form the supplementary ink layer 12 on the insulating OC 14.

The photo-curing process in the embodiment of the present disclosure may be conducted for curing UV ink via for example three (3) metal halide lamps under the following curing conditions: the light intensity of 1,200 mw/cm² and the light quantity of 3,000 mj/cm².

In the embodiment of the present disclosure, in order to avoid the possible peeling-off of the insulating OC due to the photo-curing process of the UV ink, samples of the insulating OC 14 may be subjected to curing resistance (namely light treatment) test in advance, so that a material satisfying the test requirements can be selected to prepare the insulating OC 14.

As illustrated in FIG. 4, if the supplementary ink layer 12 is disposed on the primary BMs 13, in the embodiment of the present disclosure, the processing section 1 may be adopted at first to perform plasma cleaning on the surface of the primary BMs 13, so that the surface contact angle of the primary BMs 13 can be reduced, for instance, reduced from 80 degrees to about 30 degrees, and hence the adhesion (B) between the supplementary ink layer 12 and the primary BMs 13 can be strengthened. Subsequently, the printing unit 21 may be adopted to form supplementary ink on the primary BMs 13 subjected to plasma cleaning by printing process. Then, the curing unit 22 is adopted to perform photo-curing process on the supplementary ink to form the supplementary ink layer 12 on the primary BMs 13.

Because the primary BMs 13 have low transmittance, a curing light source having a higher intensity for the UV ink is required. In one example, the curing unit 22 may be adopted to perform photo-curing process on the UV ink via three metal halide lamps under the following curing conditions: the light intensity of 1,200 mw/cm² and the light quantity of 3,000 mj/cm².

In one example, as illustrated in FIG. 5, the supplementary ink layer 12 in the embodiment of the present disclosure may also be directly formed on the cover glass plate 11. Because there is good adhesion between the UV ink and the cover glass plate 11, in the example, the processing section 1 is not required to perform plasma cleaning on the cover glass plate 11, and the manufacturing section 2 is adopted to directly form the supplementary ink layer 12 on the cover glass plate 11.

The device for manufacturing the OGS touch panel, provided by the embodiment of the present disclosure, not only comprises the processing section 1 and the manufacturing section 2 but also may comprise other server members.

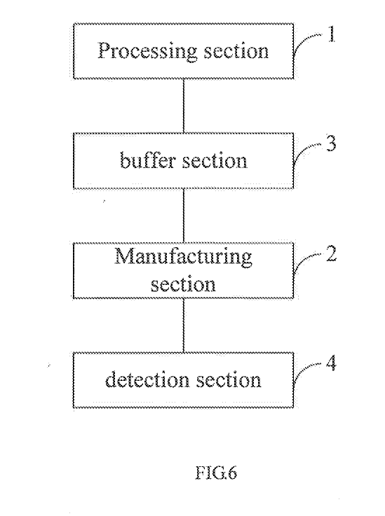

For instance, as illustrated in FIG. 6, a buffer section 3 may also be disposed between the processing section 1 and the manufacturing section 2 to perform buffer processing on the cover glass plate 11 that has been processed by the processing section 1, provide operation time for the secondary printing process of the OGS touch panel achieved by the manufacturing section 2, and transfer the cover glass plate 11 to the manufacturing section 2.

In addition, as illustrated in FIG. 6, the device may be further provided with a detection section 4 for the random detection of the existing layers on the cover glass plate 11 processed by the printing unit 21 and/or the curing unit 22, so as to determine the manufacturing effect of the manufacturing section 2 and improve the yield of the OGS touch panel.

An embodiment of the present disclosure further provides a method for manufacturing an OGS touch panel, which is configured to achieve secondary ink printing in the manufacturing process of the OGS touch panel. The method may be applied to the device for manufacturing the OGS touch panel, provided by the embodiment of the present disclosure.

Illustratively, the method may comprise: performing plasma cleaning on a layer to be coated on cover glass plate 11; and forming a supplementary ink layer 12 on the layer to be coated that has been subjected to plasma cleaning, in which the supplementary ink layer 12 is made from UV curing ink.

Illustratively, the above-described two manufacturing steps may be respectively achieved with the processing section 1 and the manufacturing section 2 in the device for manufacturing the OGS touch panel, provided by the embodiment of the present disclosure.

In one example, the step of forming the supplementary ink layer 12 may include: forming supplementary ink on the layer to be coated that has been subjected to plasma cleaning by printing process; and curing the supplementary ink by photo-curing to form the supplementary ink layer 12.

Illustratively, the above steps may be respectively executed with the printing unit 21 and the curing unit 22 in the manufacturing section 2 in the embodiment of the present disclosure.

In one example, the photo-curing process may include: irradiating the supplementary ink with a halogen lamp, with the light intensity of 1,200 mW/cm² and the light quantity of 3,000 mj/cm².

The foregoing halogen lamp, for instance, may be replaced with three metal halide lamps.

In one example, after the step of forming the supplementary ink and/or the supplementary ink layer 12, the method may further comprise: detecting the existing layers on the cover glass plate.

In one example, after the step of performing plasma cleaning and before the step of forming the supplementary ink layer 12, the method may further comprise: performing buffer processing on the cover glass plate subjected to plasma cleaning.

An embodiment of the present disclosure further provides an OGS touch panel, which may be manufactured by the device for manufacturing the OGS touch panel, provided by an embodiment of the present disclosure or the method for manufacturing the OGS touch panel, provided by an embodiment of the present disclosure.

The OGS touch panel may comprise: a cover glass plate; a layer to be coated that is disposed on the cover glass plate and subjected to plasma cleaning; and a supplementary ink layer 12 formed by a secondary ink printing process and made from UV curing ink.

In one example, the OGS touch panel provided by the embodiment of the present disclosure may comprise a cover glass plate 11, primary BMs 13, an insulating OC 14, a metal layer (not shown in the figure), an AFS (not shown in the figure) and the like layers.

Thus, the layer to be coated that is subjected to plasma cleaning may be the primary BMs 13, the insulating OC 14, the cover glass plate 11 or the like; the primary BMs 13 may be formed by a primary ink printing process.

As described in the above, in the device and the method for manufacturing the OGS touch panel, provided by embodiments of the present disclosure, the manufacturing device is provided with the processing section configured to perform plasma cleaning on the layer to be coated on the cover glass and the manufacturing section configured to form the supplementary ink layer on the layer to be coated subjected to plasma cleaning. The supplementary ink layer is made from UV curing ink. Thus, the BMs can be formed by the UV curing ink in the OGS touch panel. Therefore, the manufacturing process of the OGS touch panel can be simplified; the production efficiency of the OGS touch panel can be improved; and the manufacturing cost of the OGS touch panel.

The foregoing is only the preferred embodiments of the present disclosure. It should be noted that many improvements and modifications may be also made by those skilled in the art without departing from the principle of the present disclosure and should also fall within the scope of protection of the present disclosure.

The application claims priority to the Chinese patent application No. 201410814459.5, filed on Dec. 23, 2014, the content of which is entirely incorporated herein by reference.

What is claimed is:

1. A device for manufacturing a one-glass-solution (OGS) touch panel, configured to achieve secondary ink printing in a manufacturing process of the OGS touch panel, comprising:
a processing section configured to perform plasma cleaning on a layer to be coated on a cover glass plate; and
a manufacturing section configured to form a supplementary ink layer on the layer to be coated that has been subjected to plasma cleaning, in which the supplementary ink layer is made from UV curing ink.

2. The manufacturing device according to claim 1, wherein the manufacturing section includes:
a printing unit configured to apply supplementary ink on the layer to be coated subjected to plasma cleaning by printing process; and
a curing unit configured to cure the supplementary ink by photo-curing to form the supplementary ink layer.

3. The manufacturing device according to claim 2, wherein the curing unit includes a halogen lamp or a mercury lamp.

4. The manufacturing device according to claim 3, wherein the curing unit includes a metal halide lamp.

5. The manufacturing device according to claim 3, wherein the curing unit includes three metal halide lamps.

6. The manufacturing device according to claim 2, further comprising:
a detection section configured to detect layers existing on the cover glass plate processed by the printing unit and/or the curing unit.

7. The manufacturing device according to claim 1, further comprising:
a buffer section configured to perform buffer processing on the cover glass plate processed by the processing section and transfer the cover glass plate subjected to buffer processing to the manufacturing section.

8. A method for manufacturing an OGS touch panel, for achieving secondary ink printing in the manufacturing process of the OGS touch panel, comprising:
performing plasma cleaning on a layer to be coated on a cover glass plate; and
forming a supplementary ink layer on the layer to be coated that has been subjected to plasma cleaning, in which the supplementary ink layer is made from UV curing ink.

9. The manufacturing method according to claim 8, wherein forming of the supplementary ink layer includes:
forming supplementary ink on the layer to be coated that has been subjected to plasma cleaning by printing process; and
curing the supplementary ink by a photo-curing process to form the supplementary ink layer.

10. The manufacturing method according to claim 9, wherein the photo-curing process includes:
irradiating the supplementary ink by a halogen lamp, with a light intensity of 1,200 mw/cm² and a light quantity of 3,000 mj/cm².

11. The manufacturing method according to claim 9, after forming of the supplementary ink and/or the supplementary ink layer, further comprising:
detecting layers existing on the cover glass plate.

12. The manufacturing method according to claim 8, after the step of performing plasma cleaning on the layer to be coated on the cover glass and before the step of forming the supplementary ink layer, further comprising:
performing buffer processing on the cover glass plate that has been subjected to plasma cleaning.

13. An one-glass-solution (OGS) touch panel, comprising:
a cover glass plate;
a layer to be coated disposed on the cover glass plate and subjected to plasma cleaning; and
a supplementary ink layer formed on the layer to be coated and made from UV curing ink.

14. The OGS touch panel according to claim 13, wherein the supplementary ink layer is formed by a secondary ink printing process.

15. The OGS touch panel according to claim 14, wherein the layer to be coated includes:
primary black matrixes (BMs) formed by a primary ink printing process.

16. The OGS touch panel according to claim 14, wherein the layer to be coated is an insulating overcoat (OC); and primary BMs are formed between the insulating OC and the cover glass plate.

17. The OGS touch panel according to claim 13, wherein the supplementary ink layer is formed as a black frame of the OGS touch panel.
